(19) United States
(12) Patent Application Publication
(10) Pub. No.: US 2015/0279243 A1
(43) Pub. Date: Oct. 1, 2015

(54) Paint Identification Label

(71) Applicant: William Willes, Covington, LA (US)

(72) Inventor: William Willes, Covington, LA (US)

(21) Appl. No.: 14/624,684

(22) Filed: Feb. 18, 2015

Related U.S. Application Data
(60) Provisional application No. 61/971,737, filed on Mar. 28, 2014.

(51) Int. Cl. G09F 3/02; C09J 7/02; G09F 3/08

(52) U.S. Cl. CPC G09F 3/02; G09F 3/08; C09J 7/02

(57) ABSTRACT

A paint identification label apparatus having a rectangular shaped structure with a first side and a second side, wherein the second side thereof provides an adhesive having a peel back cover or film thereover. The first side provides a material that is adapted to be written upon via a writing implement, wherein the user can dispose the name of a paint color thereon for indication to users of the paint color in a specific room. The device can have several embodiments, wherein one embodiment can be placed over a light switch and another embodiment can be placed over a wall outlet plug. Thereafter, the user can place a light switch cover or wall outlet plate over the paint identification label for concealment until removed by the user.

### CROSS REFERENCE TO RELATED APPLICATION

This application claims the benefit of U.S. Provisional Application No. 61/950,437 filed on Mar. 10, 2014. The above identified patent application is herein incorporated by reference in its entirety to provide continuity of disclosure.

### BACKGROUND OF THE INVENTION

1. Field Of The Invention

The present invention relates to a paint identification label apparatus. More specifically the invention relates to an identification apparatus that can be placed behind a light switch cover or a wall outlet plate in order to indicate to a user the color of the paint that is on the wall.

It is often difficult for people to remember which color paint they had used to paint a room in a house, office, or other room. People often dispose of old paint cans and must write down the name of the paint in order to remember the paint color at a later date. However, hand-written notes can be easily lost, leaving the person without a way to determine which paint color was used in a room. Thus, a device for helping users to remember the paint color they used in a specific room is desired.

2. Description Of The Prior Art

Devices have been disclosed in the prior art that relate to label apparatuses. These include devices that have been patented and published in patent application publications. These devices generally relate to paint identification apparatuses. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 8,016,323 to Hunt provides a self-adhesive label having a web of siliconised polyester liner and a base label, wherein there is an upper printable surface and a lower adhesive coated surface. The present invention however, provides a paint identification apparatus that can be placed behind a light switch cover or an outlet wall plate in order to indicate to a user the color of the paint that is on the wall.

U.S. Pat. No. 5,766,716 to Barry discloses a pressure sensitive self-adhesive label having a self-adhesive base on a backing of release material. The device incorporates a booklet or folded sheet for carrying printed information. This device however, is not adapted to be placed behind a light switch cover and outlet wall plate for indicating the color of the paint on the wall wherein the invention is applied.

U.S. Patent No. 2012/0121844 to Tzannini describes a self-adhesive envelope label in a rolled form, wherein the device includes a sticker or card that is completely enclosed without having any contact with the exterior environment. The user can peel back a top layer to reveal a sticker for communicational or promotional purposes. While this may be helpful in the way of displaying advertisements and the like, it offers little utility in the way of identifying a paint color, wherein the device can be placed behind a light switch or wall outlet cover for concealment thereof.

U.S. Pat. No. 4,708,907 to Flutti allows for a writable adhesive tape having an adhesive layer on one side thereof and a writable non-adhesive layer on the other side thereof. The device provides an anti-adhesive writable coating having a polyolefin and a polyaldehyde resin. Similarly, U.S. Pat. No. 5,804,271 to Barry contemplates a self-adhesive label having a rear self-adhesive surface and a multiple page booklet in an unfolded configuration. These devices, however, do not provide a structure that is adapted to correspond with a wall outlet cover and light switch cover for adhering to a wall surface, wherein the user can dispose the name of a paint color in writing on one surface thereof.

These prior art devices have several known drawbacks. The above discussed devices do not provide a paint identification label that can be placed behind a wall outlet plate or a light switch cover in order to enable a user to remove the wall outlet plate or light switch cover for ascertaining the color of paint on a wall in a particular room. Further the above discussed devices no not provide a paint identification label apparatus having a peel back adhesive and cutouts that are adapted to coincide with a light switch cover and a wall outlet plate. In light of the devices disclosed in the prior art, it is submitted that the present invention substantially diverges in design elements from the prior art and consequently it is clear that there is a need in the art for an improvement to existing paint identification devices. In this regard the instant invention substantially fulfills these needs.

### SUMMARY OF THE INVENTION

In view of the foregoing disadvantages inherent in the known types of paint identification apparatuses now present in the prior art, the present invention provides a new paint identification apparatus wherein the same can be utilized for providing convenience for the user, wherein the user can place the paint identification apparatus behind a wall plate.

It is therefore an object of the present invention to provide a new and improved paint identification label device that has all of the advantages of the prior art and none of the disadvantages.

It is another object of the present invention to provide a paint identification label apparatus that can be utilized to indicate the color of paint in a room or other area.

Another object of the present invention is to provide a paint identification label apparatus that can be secured to the interior of a light switch cover.

Another object of the present invention is to provide a paint identification label apparatus that is adapted for use with a wall outlet plate.

Another object of the present invention is to provide a paint identification label apparatus having a cutout for placement over a light switch.

Another object of the present invention is to provide a paint identification label apparatus having a cutout for placement over a wall outlet.

Another object of the present invention is to provide a paint identification label apparatus having a removable backing disposed on an adhesive layer.

Another object of the present invention is to provide a paint identification label apparatus that provides holes for mounting to a surface.

Yet another object of the present invention is to provide a paint identification label apparatus having an adhesive for securement to a planar surface.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an embodiment of the paint identification label 11 having at least one cutout being a centrally located cutout 15 for placement over a light switch 20, wherein the device provides mounting holes 16.

FIG. 2 shows an alternative embodiment of the paint identification label apparatus 11a adapted for use with a wall outlet 13a.

FIG. 3 shows the way in which the paint identification label apparatus 11 is applied to the area between a light switch 20 and behind a light switch cover 14.

### DETAILED DESCRIPTION OF THE INVENTION

Reference is made herein to the attached drawings. Like reference numerals are used throughout the drawings to depict like or similar elements of the paint identification label. For the purposes of presenting a brief and clear description of the present invention, the preferred embodiment will be discussed as used for identifying the paint used in a room by means of a label that can be secured toa wall outlet plug or light switch. The figures are intended for representative purposes only and should not be considered to be limiting in any respect.

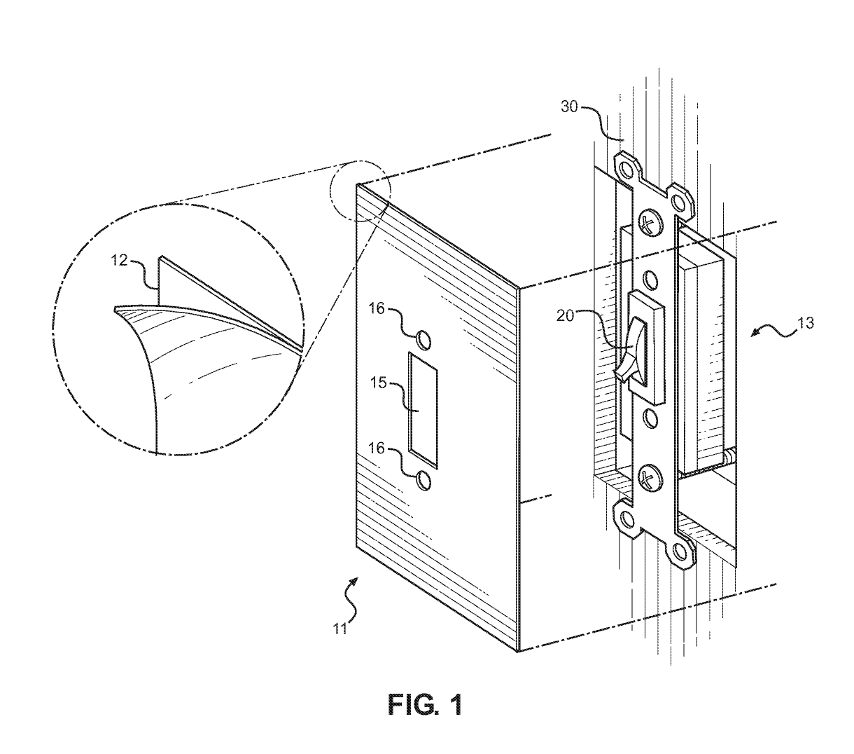

Referring now to FIG. 1, there is shown an embodiment of the paint identification label 11 having at least one cutout being a centrally located cutout 15 for placement over a light switch 20 and light switch system 13 and underneath a light switch cover, wherein the device provides mounting holes 16. The paint identification label apparatus 11 provides a rectangular shaped structure having a first side, and a second side, wherein the second side thereof comprises a fastening means, such as an adhesive. The first side including a surface adapted to be written on so that a user can write the name or other identification information of the paint used in a specific room. The surface may include paper or paperboard, or other similar surface that is easily written on using a marker, pencil, or pen. The adhesive located on the second side of the paint identification label apparatus 11 is covered by a film 12. The film 12 is a rectangular shape in a preferred embodiment and is substantially the same size and shape as the paint identification label apparatus 11, respectively. The film 12 can be translucent or clear in a preferred embodiment and is a thin structure meant for protection of the tacky properties of the adhesive over which it is placed. The film 12 protects the adhesive on the second side of the paint identification label apparatus 11, wherein the user can peel the film 12 in order to reveal the adhesive thereunder for securement to the wall area surrounding a light switch system 13 or wall outlet system.

The paint identification label 11 provides a rectangular shaped structure and a cutout 15 being a centrally located rectangular shaped cutout in one embodiment, wherein the rectangular shaped cutout 15 is adapted to be used with a light switch 20 and can fit thereover, wherein the light switch 20 can extend through the cutout 15 wherein the second side of the paint identification label apparatus 11 contact the wall surface therearound the light switch 20 and can rest flush thereagainst. The paint identification label 11 provides mounting holes 16 being a first hole and a second hole located on either side of the rectangular shaped cutout 15 in order to coincide with a light switch cover. Once the paint identification label 11 is placed over the light switch 20 and light switch system 13 and contacts the wall 30, the adhesive on the second side thereof allows the paint identification label 11 to be affixed thereto.

The user can then proceed to place a light switch cover over the light switch 20 and thus overtop of the paint identification label 11, wherein the light switch cover provides a centrally located cutout that is rectangular shaped in order to accommodate a standard light switch 20 and is placed over the light switch wherein the light switch extends therethrough and the light switch cover lays flush against the wall surface therearound. The light switch cover further provides a pair of mounting holes that are circular in shape and are integral therewith. The user can place screws through the mounting holes of the light switch cover and thus through the first hole and the second hole of the paint identification label and can extend therethrough so as to conceal the paint identification label thereunder.

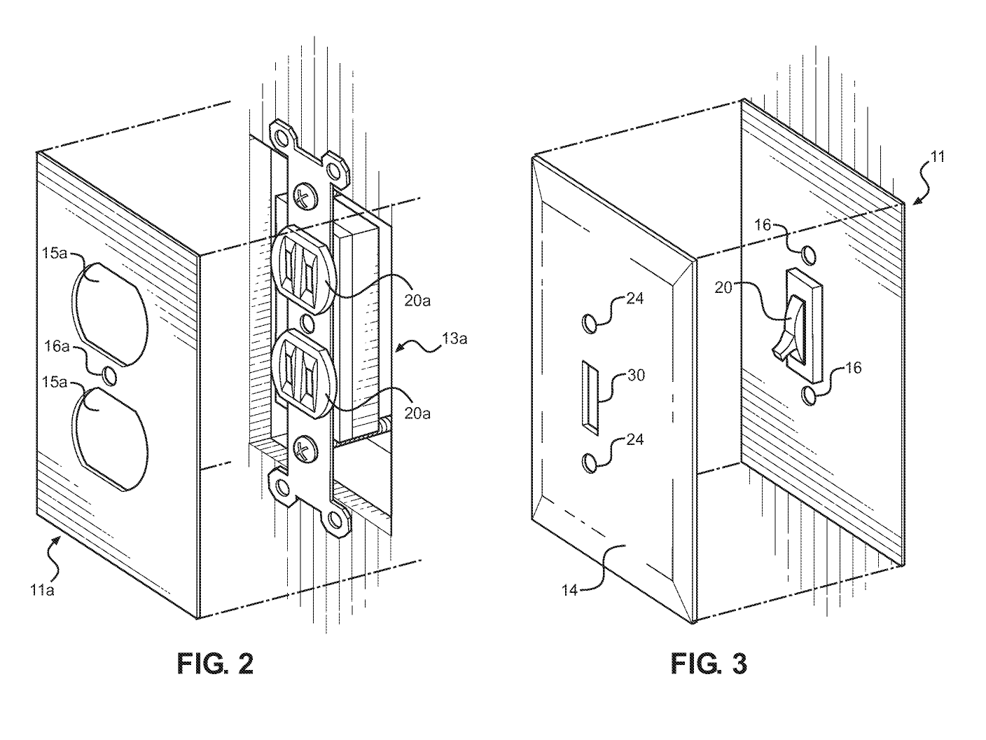

FIG. 2 shows an alternative embodiment of the paint identification label apparatus 11a adapted for use with a wall outlet 13a. The paint identification label 11a comprises a pair of cutouts 15a for placement over a wall outlet 13a and underneath a wall outlet plate, wherein the paint identification label 11a provides at least one mounting hole 16a. The paint identification label apparatus 11a provides a rectangular shaped structure having a first side, a second side, and a pair of cutouts 15a shaped similarly to electrical outlet so that the label apparatus 11a does not interfere with or cover the electrical outlet when placed thereover.

The first embodiment and the second embodiment of the paint identification label 11, 11a provides a first side that is adapted to be written upon by a writing implement, wherein the user can utilize a pen, marker, pencil, colored pencil, crayon and/or other suitable writing implement and contact the first side of the paint identification label 11a therewith and write the name of a paint color thereon that is on the walls in which the paint identification label is present. The first side of the paint identification label 11a can be made from paper, plastic, cardboard, fabric and/or other suitable material that is adapted to be written thereon via a writing implement.

FIG. 3 shows the way in which the paint identification label apparatus 11 is applied to the area between a light switch 20 and behind a light switch cover 14. The paint identification apparatus provides various embodiments as discussed above, wherein one embodiment is adapted to be placed behind a light switch cover 14 and an alternative embodiment is adapted to be placed behind a wall outlet cover. The paint identification apparatus 11 is placed over the light switch system of a standard electrical light system or wall outlet system. The user can remove the film placed overtop the adhesive on the second side of the sheet and discard the film. The user can place the adhesive on the second side of the sheet onto the wall area surrounding the wall outlet or light switch system for securement thereto, wherein the light switch 20 extends through the cutout 15 of the light switch embodiment and the sockets of the wall outlet extend through the pair of cutouts of the alternative embodiment. Once the paint identification label apparatus 11 is placed onto the wall, the user can place the wall outlet plate or light switch cover 14 over top of the paint identification label apparatus 11.

The user can then proceed to place a light switch cover 14 over the light switch 20 and thus overtop of the paint identification label 11, wherein the light switch cover 14 provides a centrally located cutout 15 that is rectangular shaped in order to accommodate a standard light switch 20 and is placed over the light switch 20 wherein the light switch 20 extends therethrough and the light switch cover 14, and wherein the light switch cover 14 lays flush against the wall surface therearound. The light switch cover 14 further provides a pair of mounting holes 24 that are circular in shape and are integral therewith. The user can place nails, screws, bolts and/or other suitable fasteners, wherein the user can place screws through the mounting holes 24 of the light switch cover and thus through the first mounting hole 16 and the second mounting hole 16 of the paint identification label 11 and can extend therethrough.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A paint identification label apparatus, comprising:
a sheet having a first side and a second side, wherein said second side comprises a fastening means;
said first side of said sheet being adapted to be written upon by a writing implement;
at least one cutout disposed on said sheet;
at least one mounting hole disposed on said sheet.

2) The paint identification label apparatus of claim 1, wherein said sheet comprises a rectangular shape.

3) The paint identification label apparatus of claim 1, wherein said fastening means on said second side of said sheet comprises an adhesive, said adhesive having a film thereover, said film being adapted to remain flush against said second side of said sheet until removal thereof.

4) The paint identification label apparatus of claim 2, wherein said at least one cutout comprises a rectangular shape that is centrally located on said sheet, said at least one mounting hole being a pair of holes disposed in an opposing orientation to one another and adjacent to said at least one cutout.

5) The paint identification label apparatus of claim 1, wherein said at least one cutout comprises a pair of cutouts, said pair of cutouts being substantially circular shaped, said at least one mounting hole being one mounting hole centrally located and disposed between said pair of cutouts.

6) The paint identification label apparatus of claim 1, said fastening means having a cover thereover, said cover being rectangularly shaped and adapted to readily fit over said paint identification label apparatus.
